(19) United States
(12) Patent Application Publication
(10) Pub. No.: US 2010/0009723 A1
(43) Pub. Date: Jan. 14, 2010

(54) APPARATUS AND METHOD FOR ADJUSTING RING TONE FUNCTION OF COMMUNICATIONS DEVICE

(75) Inventors: Chuan-Hong Wang, Tu-Cheng (TW); Xiao-Guang Li, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/408,729

(22) Filed: Mar. 23, 2009

(30) Foreign Application Priority Data
Jul. 8, 2008 (CN) 200810302650.6

(51) Int. Cl. H04B 1/38

(52) U.S. Cl. 455/567

(57) ABSTRACT

The present invention provides an apparatus and a method for adjusting a ring tone function of a communications device. The method includes: a) receiving incoming call signals; b) fetching a predetermined ring tone and a transition rule according to a predetermined age; c) adjusting the predetermined ring tone according to the transition rule; and d) outputting the adjusted ring tone.

### TECHNICAL FIELD

The disclosure relates to a communications device and, more particularly, to an apparatus and a method for adjusting a ring tone function of the communications device.

### GENERAL BACKGROUND

In general, the frequency range of human hearing is between 20 and 20,000 Hz. However, as a person gets older the frequency range may narrow, particularly, the person may lose the ability to hear the higher frequencies. Commonly, people above the age of 35 cannot distinguish frequencies above 17,000 Hz. Therefore, communications devices with ring tones including frequencies near or above 17,000 Hz may fail to alert a number of users to incoming calls.

Accordingly, what is needed in the art is an apparatus and a method for adjusting a ring tone function of a communications device that overcomes the aforementioned deficiencies.

### BRIEF DESCRIPTION OF THE DRAWINGS

The components in the drawings are not necessarily drawn to scale, the emphasis instead being placed upon clearly illustrating the principles of the communications device. Moreover, in the drawings, like reference numerals designate corresponding parts throughout the several views.

FIG. 1 is a block diagram of a hardware infrastructure of a communications device in accordance with an exemplary embodiment.

FIG. 2 is a flowchart for adjusting a ring tone of the communications device of FIG. 1.

### DETAILED DESCRIPTION OF THE EMBODIMENTS

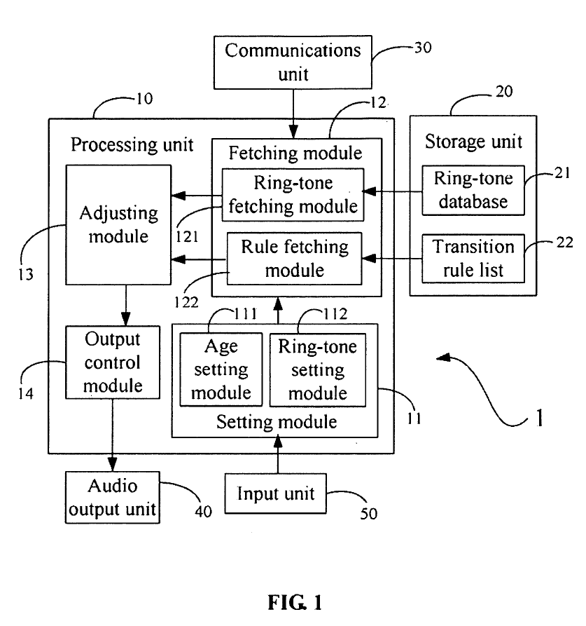

FIG. 1 is a block diagram of a hardware infrastructure of a communications device such as a cellular phone 1 in accordance with an exemplary embodiment. The cellular phone 1 includes a processing unit 10, a storage unit 20, a communications unit 30, an audio output unit 40, and an input unit 50. The communications unit 30 is configured, among other things, for receiving incoming call signals from an external wireless communications system (not shown). The input unit 50 is configured for generating input signals from a user.

The storage unit 20 is configured for storing a ring-tone database 21 and a transition rule list 22. The ring-tone database 21 stores a plurality of ring tones. The transition rule list 22 is provided to store relationships between user's age and transition rules. The transition rule list 22 includes an age column and a transition rule column. In this embodiment, the age column records a plurality of age ranges, such as less than 35 years old, more than 50 years old, and between 35 and 50 years old. The transition rule column records a plurality of transition rules corresponding to the age ranges, such as high frequency, intermediate frequency, and low frequency.

For example, as shown in an exemplary transition rule list 22 below, where N equals the age of the user, there is no need to adjust frequencies for the transition rule in case of N<35, this is a first frequency range; the transition rule for 35<=N<=50 is to adjust to a second frequency range, and the transition rule for 50<N is to adjust to a third frequency range. The frequency ranges can be, for example, 20-20,000 Hz for the first frequency range, 20-18,500 Hz for the second frequency range, and 20-17,000 Hz for the third frequency range.

### Transition Rule List

| Age | Transition rule |
|---|---|
| N < 35 | First frequency range = No adjustment |
| 35 <= N <= 50 | Adjust to second frequency range |
| 50 < N | Adjust to third frequency range |

The processing unit 10 is configured for controlling the cellular phone 1. The processing unit 10 includes a setting module 11, a fetching module 12, an adjusting module 13 and an output control module 14. The setting module 11 further includes a ring-tone setting module 112 and an age setting module 111. The ring-tone setting module 112 is configured for setting a ring tone from the ring-tone database 21 according to a first input signal generated from the input unit 50, for example, setting a song A as the ring tone of the cellular phone 1. The age setting module 111 is configured for setting an age of the transition rule list 22 according to a second input signal generated from the input unit 50, for example, setting 50<N as the age of the cellular phone 1.

The fetching module 12 further includes a ring-tone fetching module 121 and a rule fetching module 122. The ring-tone fetching module 121 is configured for fetching the predetermined ring tone from the ring-tone setting module 112 when the communications unit 30 receives the incoming call signals. The rule fetching module 122 is configured for fetching the transition rule from the transition rule list 22 according to the predetermined age from the age setting module 111 when the communications unit 30 receives the incoming call signals. For example, when the age setting module 111 sets the age of 50<N, the rule fetching module 122 fetches the transition rule that is to adjust to the third frequency range.

The adjusting module 13, connected to the fetching module 12, is configured for adjusting the ring tone from the ring-tone fetching module 121 according to the transition rule from the rule fetching module 122. The output control module 14 is configured for controlling the audio output unit 40 to output the adjusted ring tone. The audio output unit 40 is configured for outputting the adjusted ring tone, such as a speaker (not shown).

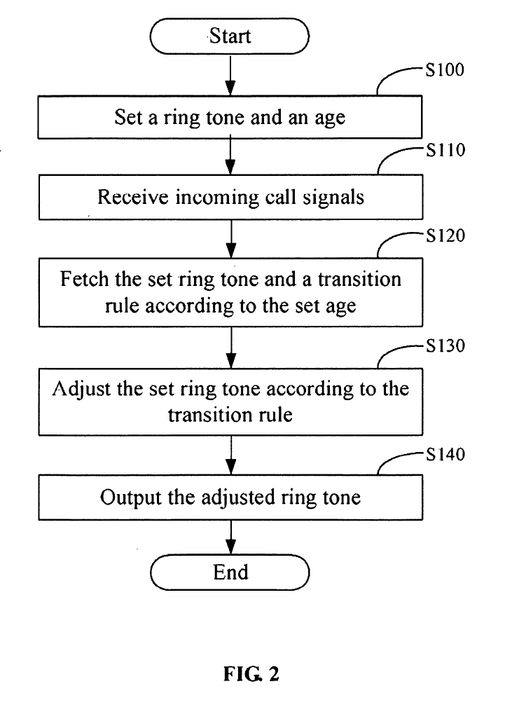

FIG. 2 is a flowchart for adjusting a ring tone of the communications device such as the cellular phone 1 of FIG. 1. In step S100, The ring-tone setting module 112 sets a ring tone from the ring-tone database 21 according to the first input signal generated from the input unit 50 and the age setting module 111 sets an age of the transition rule list 22 according to the second input signal generated from the input unit 50. In step S110, the communications unit 30 receives the incoming call signals from the external wireless communications system. In step S120, the ring-tone fetching module 121 fetches the set ring tone from the ring-tone database 21, and the rule fetching module 122 fetches the transition rule from the transition rule list 22 according to the set age. In step S130, the adjusting module 13 adjusts the set ring tone according to the transition rule from the rule fetching module 122. In step S140, the output control module 14 controls the audio output unit 40 to output the adjusted ring tone.

In other embodiments, step S100 may be omitted and the action may be automatically performed with default settings. In step S120, the ring-tone fetching module 121 automatically fetches the default ring tone of the cellular phone 1, and the rule fetching module 122 fetches the transition rule from the transition rule list 22 according to the default age of the cellular phone 1.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A communications device comprising:
a storage unit for storing ring tones and a transition rule;
an input unit configured for generating input signals from a user;
a communications unit configured for receiving incoming call signals;
a ring-tone fetching module configured for fetching a predetermined ring tone from the storage unit when the communications unit receives the incoming call signals;
a rule fetching module configured for fetching a transition rule from the storage unit according to a predetermined age when the communications unit receives the incoming call signals;
an adjusting module configured for adjusting the predetermined ring tone according to the transition rule; and
an audio output unit configured for outputting the adjusted ring tone.

2. The communications device as recited in claim 1, further comprising an output control module configured for controlling the audio output unit to output the adjusted ring tone.

3. The communications device as recited in claim 1, further comprising a ring-tone setting module configured for setting the predetermined ring tone according to a first input signal from the input unit.

4. The communications device as recited in claim 1, further comprising an age setting module configured for setting the predetermined age according to a second input signal from the input unit.

5. The communications device as recited in claim 4, wherein a plurality of age ranges are used for setting the predetermined age into one of the plurality of age ranges; each age range has a corresponding transition rule.

6. The communications device as recited in claim 5, wherein the plurality of age ranges comprises three age ranges, corresponding to high frequency transition rule, intermediate frequency transition rule, and low frequency transition rule, respectively.

7. A method for adjusting a ring tone of a communications device, comprising;
receiving incoming call signals;
fetching a predetermined ring tone and a transition rule according to a predetermined age;
adjusting the predetermined ring tone according to the transition rule; and
outputting the adjusted ring tone.

8. The method as recited in claim 7, further comprising: setting the predetermined ring tone according to a first input signal from a user.

9. The method as recited in claim 7, further comprising: setting the predetermined age according to a second input signal from the user.

10. The method as recited in claim 9, wherein a plurality of age ranges are used for setting the predetermined age into one of the plurality of age ranges; each age range has a corresponding transition rule.

11. The method as recited in claim 10, wherein the plurality of age ranges comprises three age ranges, corresponding to high frequency transition rule, intermediate frequency transition rule, and low frequency transition rule, respectively.
